(19) United States
(12) Patent Application Publication
(10) Pub. No.: US 2010/0032575 A1
(43) Pub. Date: Feb. 11, 2010

(54) METHODS AND SYSTEMS FOR PET/CT SCANNING FOR EVALUATION OF MALIGNANCY

(76) Inventors: Andrei Iagaru, Sunnyvale, CA (US); Michael L. Goris, Sunnyvale, CA (US); Sanjiv S. Gambhir, Portola Valley, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/534,458

(22) Filed: Aug. 3, 2009

Related U.S. Application Data
(60) Provisional application No. 61/087,376, filed on Aug. 8, 2008.

(51) Int. Cl. G01T 1/164

(52) U.S. Cl. 250/362; 250/363.03

(57) ABSTRACT

Embodiments of the methods of the present disclosure allow interpretation of the ¹⁸F and ¹⁸F-FDG tissue distribution, even though the two radiopharmaceuticals are administered at the same time. This approach is based on the eventual localization of the ¹⁸F almost exclusively to the skeletal structures. Another aspect of the disclosure is a computer-based method for overlapping PET and CT scan images obtained after the simultaneous administration of ¹⁸F and ¹⁸F-FDG, thereby proving improved clarity and detection of malignancies.

### CROSS-REFERENCE TO RELATED APPLICATIONS

This application claims priority to U.S. Provisional Patent Application Ser. No. 61/087,376, entitled “A NOVEL STRATEGY FOR A COCKTAIL ¹⁸F FLUORIDE AND ¹⁸F-FDG PET/CT SCAN FOR EVALUATION OF MALIGNANCY” filed on Aug. 8, 2008, the entirety of which is hereby incorporated by reference.

### STATEMENT REGARDING FEDERALLY SPONSORED RESEARCH OR DEVELOPMENT

This disclosure was made with government support under NIC ICMIC Grant No. CA 114747 awarded by the U.S. National Institutes of Health of the United States government. The government has certain rights in the disclosure

### TECHNICAL FIELD

The present disclosure is generally related to methods of detecting a malignancy in a patient by administering thereto an ¹⁸F-Fluoride and an ¹⁸F-FDG and subjecting the patient to a PET/CT scan. The disclosure further relates to methods superimposing PET and CT scans to identify malignancy lesions in a patient.

### BACKGROUND

Fluorine-18 2-Fluoro 2-deoxyglucose (¹⁸F-FDG) positron emission tomography and computed tomography (PET/CT) is established as a powerful imaging tool for cancer detection and monitoring response to therapy. However, not all cancers are reliably identified, due to variable rates of glucose metabolism. Sodium Fluoride-18 (¹⁸F) was used in the 1970's for bone scanning and can be used as a skeletal radiopharmaceutical in current PET/CT scanners. Both types of scans may be needed for accurate initial evaluation of the extent of disease in some cancer patients. The present disclosure encompasses strategies for the combined administration of ¹⁸F and ¹⁸F-FDG in a single PET/CT scan for cancer detection.

By using both direct image interpretation and image processing, the ¹⁸F/¹⁸F-FDG PET/CT scans are shown to compare favorably with the individual ¹⁸F-FDG PET/CT scans or ¹⁸F PET/CT scans. The pilot phase trial demonstrated the feasibility of a combined administration of ¹⁸F/¹⁸F-FDG followed by a single PET/CT examination for the detection of malignancy.

The basis of clinical radionuclide based molecular imaging is to provide functional information by imaging patients after they have been injected with a radiopharmaceutical that circulates inside them and is incorporated into various cellular processes. This general principle has been applied for many years in Nuclear Medicine using various radiopharmaceuticals and gamma cameras. However, it is the more recent advent of positron emission tomography (PET) for oncology that has sparked a renewed interest in molecular imaging because of the greater resolution/sensitivity of this modality, and also because of the radiopharmaceutical ¹⁸F-2-Fluoro 2-deoxyglucose (¹⁸F-FDG) that has enabled imaging of a wide variety of malignancies.

PET imaging technology advanced further after the introduction of the combined positron emission tomography and computed tomography (PET/CT) scanner, which allows fused visualization of complementary functional and anatomical information. The role of ¹⁸F-FDG PET/CT is proven in a variety of cancers, including lymphoma, colorectal carcinoma, lung cancer and melanoma, entities for which it changed the practice of oncology (Gambhir, S. S. (2002) Nat. Rev. Cancer 2: 683-693). However, not all malignant lesions are identified reliably due to variable rates of glucose metabolism, contributing to the overall limitations of ¹⁸F-FDG PET/CT (Gambhir, S. S. (2002) Nat. Rev. Cancer 2, 683-693).

Initial staging of patients diagnosed with certain cancers involves imaging with ¹⁸F-FDG PET/CT and Technetium-99m (^{99m}Tc) Methylenediphosphonate (MDP) bone scintigraphy (Podoloff et al. (2007) J. Natl. Compr. Canc. Netw. 1: S1-S22; Savelli et al. (2001) Q. J. Nucl. Med. 45: 27-37). Traditionally, ^{99m}Tc-MDP bone scintigraphy is the method of choice for evaluation of osseous metastases since it allows a whole body survey at a relatively reduced cost, and because the sensitivity is not based on the size of the tumor but the response of the bone to the presence of metastasis. Successful imaging of skeletal metastases is possible for prostate, breast and certain other malignancies.

Skeletal scintigraphy applications include initial staging, monitoring the response to therapy and detection of areas at risk for pathological fracture. Although ^{99m}Tc-MDP scintigraphy is sensitive for the detection of advanced skeletal metastatic lesions, early involvement may be missed in some cases in the absence of an osteoblastic response because this technique relies on the identification of this response rather than the detection of the tumor itself. Limitations imposed by the spatial resolution of planar scintigraphy and single photon emission computed tomography (SPECT) also affect the sensitivity of bone scintigraphy in detection of osseous metastases (Even-Sapir, E. (2005) J. Nucl. Med. 46: 1356-1367; Grant, F. D. et al. (2008) J. Nucl. Med. 49: 68-78).

Prior to introduction of ^{99m}Tc based agents, planar bone scintigraphy with sodium fluoride-18 (¹⁸F) was performed and achieved excellent quality studies (Shirazi et al., Radiology. 112: 361-368 (1974). ¹⁸F is an avid bone seeker because it is an analogue of the hydroxyl group found in hydroxyapatite bone crystals. ¹⁸F has the desirable characteristics of high and rapid bone uptake accompanied by very rapid blood clearance of unabsorbed ¹⁸F, which results in a high bone-to-background ratio in a short time. High-quality images of the skeleton can be obtained less than an hour after the intravenous administration of ¹⁸F. Since ¹⁸F is a positron emitter, it also allows for PET imaging.

### SUMMARY

Embodiments of the methods of the present disclosure allow interpretation of the ¹⁸F and ¹⁸F-FDG tissue distribution, even though the two radiopharmaceuticals are administered at the same time. This approach is based on the eventual localization of the ¹⁸F almost exclusively to the skeletal structures. One aspect of the present disclosure encompasses methods of determining the extent of cancer metastasis in a subject human or animal, comprising the steps of: (a) administering to a subject animal or human a first radiopharmaceutical and a second radiopharmaceutical; (b) capturing a positron emission tomography (PET) scan image of the subject administered a first radiopharmaceutical and a second radiopharmaceutical, where the PET scan image indicates the locations of the first radiopharmaceutical and the second radiopharmaceutical in the subject; and (c) identifying from the PET scan a site of co-localization of the first radiopharmaceutical and the second radiopharmaceutical in the subject, the co-localization indicating a metastatic cancer in the subject.

In embodiments of this aspect of the disclosure, the methods may further comprise: (i) capturing a computed tomography (CT) scan image of the subject animal or human, where the CT scan image can indicate the osseous material of the subject; (ii) adjusting the CT scan image to the size and resolution substantially similar to the PET image; (iii) adjusting the CT scan image data to retain only bone density data, thereby generating a digital bone mask image; (iv) overlaying the digital bone mask image with the PET scan image, thereby providing a PET scan image-digital bone mask image with the locations of the first radiopharmaceutical and the second radiopharmaceutical in the subject displayed thereon; and (v) identifying from the PET scan image-digital bone mask image overlay a site of co-localization of the first radiopharmaceutical and the second radiopharmaceutical in the subject.

In embodiments of the disclosure, the first radiopharmaceutical can be preferentially incorporated into bone, and the second radiopharmaceutical can be preferentially used by a cancer cell. In embodiments of this aspect of the disclosure, the first radiopharmaceutical can be, for example, ¹⁸F⁻ and the second radiopharmaceutical can be ¹⁸F-2-deoxyglucose.

In the embodiments of the method of this aspect of the disclosure, the step of manipulating the CT scan image can further comprise performing image thresholding on the CT scan image.

Another aspect of the disclosure provides systems comprising: a processor; and a computer readable medium storing program code to be executed by the processor, where the program code comprises logic configured to: capture a positron emission tomography (PET) scan image of a subject administered a first radiopharmaceutical and a second radiopharmaceutical, the PET scan image indicating the locations of the first radiopharmaceutical and the second radiopharmaceutical in the subject; identify from the PET scan image the locations of the first radiopharmaceutical and the second radiopharmaceutical in the subject; capture a computed tomography (CT) scan image of the subject, the CT scan indicating osseous material in the subject; adjust the CT scan image to a size and a resolution substantially similar to the PET image; adjust the CT scan image to retain bone density data of the subject to form a digital bone mask image; overlay the PET scan image onto the digital bone mask, thereby forming a combined PET scan image-digital bone mask image overlay; and identify from the PET scan image-digital bone mask image overlay a site of co-localization of the first radiopharmaceutical and the second radiopharmaceutical in the subject.

In embodiments of this aspect of the disclosure, the first radiopharmaceutical can be absorbed by osseous material and the second radiopharmaceutical can be absorbed by cancer cells. In the various embodiments of the disclosure, the first radiopharmaceutical can be, for example, ¹⁸F⁻ and the second radiopharmaceutical can be ¹⁸F-2-deoxyglucose.

In the various embodiments of this aspect of the disclosure, the logic configured to manipulate the CT scan image can further comprise logic configured to perform image thresholding on the CT scan image. Yet another aspect of the disclosure provides systems, comprising: a processor; a means to capture a first scan image of a subject administered at least one tracer, the scan image indicating the at least one tracer in the subject; a means to capture a second scan image of the subject, the scan image indicating osseous material in the subject; and a means to adjust the second scan image to a size and a resolution substantially similar to the first image, whereby the second scan image forms a digital bone mask image overlay on the first scan image, thereby identifying from the first scan image a site of co-localization of the at least one tracer in the subject.

### BRIEF DESCRIPTION OF THE FIGURES

Many aspects of the disclosure can be better understood with reference to the following figures.

See the text and examples for a more detailed description of the figures.

FIG. 1 illustrates sagital views of an imaged mouse: a) ¹⁸F-FDG microPET; b) combined ¹⁸F/¹⁸F-FDG microPET; c) bone window images from microCT used as a mask for the display of skeletal ¹⁸F/¹⁸F-FDG uptake on microPET; and d) Skeletal distribution of the ¹⁸F/¹⁸F-FDG after substraction of uptake outside the osseous structures using the microCT bone mask.

FIG. 2 illustrates the scan results from a 59 year old man with lung cancer: a) combined ¹⁸F/¹⁸F-FDG image; b) bone scan obtained with ¹⁸F PET; and c) processed combined ¹⁸F/¹⁸F-FDG images are similar to the skeletal distribution of ¹⁸F alone.

FIG. 3 illustrates the scan results from a 44 year old man with soft tissue sarcoma: a) MIP image of the ¹⁸F-FDG PET shows normal radiopharmaceutical uptake; b) MIP image of the ¹⁸F PET shows intense radiopharmaceutical uptake in a skull lesion (arrow), as well as T10 vertebra and right pubis (arrowheads); c) the skull lesion is missed on the MIP of the combined ¹⁸F/¹⁸F-FDG PET, but the MIP of the combined ¹⁸F/¹⁸F-FDG PET shows the skeletal lesions in T10 vertebra and right pubis noted on ¹⁸F PET (arrowheads); the skull lesion (arrow) is seen on transaxial CT (d) and ¹⁸F PET (e), but not on the combined ¹⁸F/¹⁸F-FDG PET (f); and the lesion in T10 vertebra (arrowhead) is seen on transaxial CT (g), ¹⁸F PET (h) and combined ¹⁸F/¹⁸F-FDG PET (i).

FIG. 4 illustrates the scan results from a 68 year old man with colon cancer. a) MIP image of the ¹⁸F-FDG PET shows faint radiopharmaceutical uptake in several skeletal lesions (arrowheads); b) MIP image of the ¹⁸F PET shows intense radiopharmaceutical uptake in multiple bone lesions, including better visualization of the lesions seen on ¹⁸F-FDG PET (arrowheads) and more extensive skeletal metastases (arrows); and c) MIP of the combined ¹⁸F/¹⁸F-FDG PET shows the skeletal lesions noted on ¹⁸F PET (arrowheads).

FIG. 5 illustrates the scan results from a 75 year old man with prostate cancer. a) maximum intensity projection (MIP) image of the ¹⁸F-FDG PET shows lymph nodes metastases (arrowheads), as well as faint uptake in osseous lesions, such as a right rib (arrow); b) MIP image of the ¹⁸F PET shows intense radiopharmaceutical uptake in multiple bone lesions, including the right rib lesion (arrow) seen on ¹⁸F-FDG PET; and c) MIP of the combined ¹⁸F/¹⁸F-FDG PET shows both the lesions noted on ¹⁸F-FDG PET (arrowheads) and the skeletal lesions noted on ¹⁸F PET (reference right rib lesion marked with arrow).

FIG. 6 illustrates: a) the first step is to reformat the CT to the dimensions of the PET; b) the bed is eliminated by indicating the most dependent part of the body as the image limit; c) the CT is interactively thresholded to eliminate all soft tissue but keeping bone densities; and d) the PET image multiplied by the mask leaves the bone image with a combined ¹⁸F/¹⁸F-FDG uptake.

FIG. 7 illustrates a scan imager that can be configured to perform the various image processing tasks in accordance with one embodiment of the disclosure.

FIG. 8 depicts a flowchart showing a method in accordance with one embodiment of the disclosure.

### DESCRIPTION OF THE DISCLOSURE

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those skilled in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. patent law and the term is open-ended, allowing for the presence of more than that which is recited so long as basic or novel characteristics of that which is recited is not changed by the presence of more than that which is recited, but excludes prior art embodiments.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified.

The term “substantially” as used herein, refers to any proportion of an object, property of an object, composition, or system parameter, wherein the proportion is greater than 50%, more preferably greater than 60%, more preferably greater than 70%, more preferably greater than 80%, more preferably greater than 90%, and more preferably greater than 95% of the whole.

The term “Positron Emission Tomography (PET)” as used herein refers to a nuclear imaging technique used in the medical field to assist in the diagnosis of diseases. PET allows the physician to examine the whole patient at once by producing pictures of many functions of the human body unobtainable by other imaging techniques. In this regard, PET displays images of how the body works (physiology or function) instead of simply how it looks. PET is considered the most sensitive, and exhibits the greatest quantification accuracy of any nuclear medicine imaging instrument available at the present time. Applications requiring this sensitivity and accuracy include those in the fields of oncology, cardiology, and neurology.

The term “radiopharmaceutical” as used herein refers to radioactive pharmaceuticals used in the field of nuclear medicine as radiopharmaceuticals in the diagnosis and treatment of many diseases. Many radiopharmaceuticals use technetium (Tc-99m), ¹⁸F, and the like.

In PET, short-lived positron-emitting isotopes, herein referred to as radiopharmaceuticals or radiopharmaceuticals, are injected into a patient. When these radioactive drugs are administered to a patient, they distribute within the body according to the physiologic pathways associated with their stable counterparts. For example, the radiopharmaceutical ¹⁸F-labeled glucose, known as fluorodeoxyglucose or “FDG”, can be used to determine where normal glucose would be used in the brain. Other radioactive compounds, such as ¹¹C-labeled acetate, ¹³N-labeled ammonia or ¹⁵O-labeled water, are used to study such phenomena as neoplastic transformation or blood flow.

As the FDG or other radiopharmaceutical isotopes decay in the body, they produce positively charged particles called positrons. The positrons encounter electrons, and both are annihilated. As a result of each annihilation event, gamma rays are generated in the form of a pair of diametrically opposed photons approximately 180 degrees (angular) apart. By detecting these annihilation “event pairs” for a period of time, the isotope distribution in a cross section of the body can be determined, thereby identifying the site(s) of radiopharmaceutical concentration. These events are mapped within the patient's body, thus allowing for the quantitative measurement of metabolic, biochemical, and functional activity in living tissue. More specifically, PET images (often in conjunction with an assumed physiologic model) are used to evaluate a variety of physiologic parameters such as glucose metabolic rate, cerebral blood flow, tissue viability, oxygen metabolism, and in vivo brain neuron activity. Methods of capturing PET scan images are known in the art.

Mechanically, a PET scanner consists of a bed or gurney and a gantry, which is typically mounted inside an enclosure with a tunnel through the center, through which the bed traverses. The patient, who has been injected with a radiopharmaceutical, lies on the bed, which is then moved into the tunnel formed by the gantry. The gantry is rotated around the patient as the patient passes through the tunnel. The rotating gantry contains the detectors and a portion of the processing equipment. Signals from the rotating gantry are fed into a computer system where the data is then processed to produce images.

The PET scanner detectors are located around the circumference of the tunnel. The detectors use a scintillating crystal to detect the gamma rays. Suitable material used for the scintillators includes, but is not limited to, lutetium oxyorthosilicate (LSO) or bismuth germanate (BGO). The light output from the scintillator is in the form of light pulses corresponding to the interactions of gamma rays with the crystal. A photodetector, typically a photomultiplier tube (PMT) or an avalanche photodiode, detects the light pulses. The light pulses are counted and the data is sent to a processing system.

The term “computed axial tomography (CAT, or now also referred to as CT, XCT, or x-ray CT)” as used herein refers to an imaging system where an external x-ray source is passed around a patient. Detectors around the patient then respond to the x-ray transmission through the patient to produce an image of the area of study. Unlike PET, which is an emission tomography technique because it relies on detecting radiation emitted from inside the patient, CT is a transmission tomography technique which utilizes a radiation source external to the patient. CT provides images of the internal structures of the body, such as the bones, whereas PET provides images of the functional aspects of the body, usually corresponding to an internal organ or tissue. Methods of capturing CT scan images are known in the art.

The CT scanner uses a similar mechanical setup as the PET scanner. However, unlike the pairs of PET scanner detectors required to detect the gamma rays from an annihilation event, the CT scanner requires detectors mounted opposite an x-ray source. In third-generation computed tomography systems, the CT detectors and x-ray source are mounted on diametrically opposite sides of a gantry which is rotated around the patient as the patient traverses the tunnel.

The x-ray source emits a fan-shaped beam of x-rays which pass through the patient and are received by an array of detectors. As the x-rays pass through the patient, they are attenuated as a function of the densities of objects in their path. The output signal generated by each detector is representative of the electron densities of all objects between the x-ray source and the detector.

The CT detectors can utilize scintillator crystals which are sensitive to the energy level of the x-rays. Multiple light pulses produced by each scintillator crystal as it interacts with the x-rays are integrated to produce an output signal which is related to the number of the x-rays sensed by the scintillator crystal. The individual output signals are then collectively processed to generate a CT image. Other detectors can be used in CT tomographs. For example, a solid state silicon diode can be used to detect the low energy x-rays directly.

The medical images provided by the PET scanner and CT scanner are complementary, and it is advantageous to have images from both types of scans. To be most useful, the PET and CT images need to be overlaid or co-registered such that the functional features in the PET images can be correlated with the structural features, such as bones, tumors, and lung tissue, in the CT images. The potential to combine functional and anatomical images is a powerful one, and there has been significant progress in the development of multi-modality image co-registration and alignment techniques. However, with the exception of the brain, the re-alignment of images from different modalities is not straightforward or very accurate, even when surface markers or reference points have been used.

One mechanical solution has been to incorporate PET and CT scanners into a single gantry, thereby allowing the images to be taken sequentially within a short period of time and overcoming alignment problems due to internal organ movement; variations in scanner bed profile, and positioning of the patient for the scan. The scanner is preferably a conventional hybrid CT imaging device such as a PET/CT scanner operable to provide emission and transmission data corresponding to PET and CT.

The most formidable barrier to the use of PET is its cost. A cyclotron is required to generate the positron-emitting radiopharmaceuticals required in the imaging procedure, and a complex detector array is required to detect photon emission. Capital equipment costs of the imaging device and cyclotron are very high. In addition, radiochemists are needed to perform complex syntheses of radiopharmaceuticals whose half-lives are typically 2 hours. Because of the high capital equipment, materials, and labor costs, the cost of a PET scan to the patient can be prohibitive.

A second disadvantage of PET is the lower spatial resolution of PET images compared to those generated by CT or MRI (Magnetic resonance Imaging). Relatively low spatial resolution is a limitation common to imaging modalities that depend on detector arrays for the measurement of high-energy particles emitted from radiopharmaceuticals. Because of its low spatial resolution, PET exhibits a high rate of false negatives in the detection of small malignant tumors (less than 0.7-1.0 cm).

A third disadvantage of PET is the length of the imaging procedure. The time required for a patient to be immobile during a PET scan may be 30-45 minutes, while radiographic images can be acquired in a few minutes.

Significant advantages of ^{99m}Tc-MDP skeletal scintigraphy and SPECT are its high sensitivity in detecting early disease of many types. However, its major limitation is the lack of specificity. Although ^{99m}Tc-MDP scintigraphy is sensitive for the detection of advanced skeletal metastatic lesions, early stage lesions may be missed because this technique relies on the identification of the osteoblastic reaction of the involved bone, rather than the detection of the tumor itself. The technique further relies significantly on the regional blood flow to bone.

Limitations imposed by the spatial resolution of planar scintigraphy and SPECT affect the sensitivity of bone scintigraphy in the detection of osseous metastases. ¹⁸F planar bone scanning was performed prior to introduction of ^{99m}Tc-based agents, achieving excellent quality studies, but the high costs of ¹⁸F prevented its routine clinical utilization. However, ¹⁸F-PET/CT was shown to be superior in bone lesion detection over the ^{99m}Tc-MDP bone scan and SPECT procedure (Even-Sapir et al. (2006) J. Nucl. Med. 47: 287-297).

¹⁸F-FDG PET/CT contributes unique information regarding the metabolic activity of musculoskeletal lesions. By supplying a physiologic basis for more informed treatment and management, it influences prognosis and survival (Feldman et al., (2003) Skeletal Radiol. 32: 201-208). It is probable, but not certain, that for breast and lung cancers, ¹⁸F-FDG PET/CT has similar sensitivity, although poorer specificity, when compared with bone scintigraphy. However, several researchers have concluded that ^{99m}Tc-SPECT is superior to ¹⁸F-FDG PET in detecting bone metastases in breast cancer, and ¹⁸F-FDG PET/CT sensitivity for osteoblastic lesions is limited (Uematsu et al., (2005) Am. J. Roentgenol. 184: 1266-1273; Nakai et al., (2005) Eur. J. Nucl. Med. Mol. Imaging. 32:1253-1258).

Surveillance of metastatic spread to the skeleton in breast cancer patients based on ¹⁸F-FDG PET alone, therefore, is not possible. There is also evidence that for prostate cancer, ¹⁸F-FDG PET is less sensitive than bone scintigraphy. Consequently, ¹⁸F-FDG PET has limited ability to detect osseous metastatic lesions, but can still be useful in the detection of metastatic nodal and soft tissue disease (Jadvar et al., (2003) Oncol. Rep. 10: 1485-1488). There is little data relating to detection of lymphoma, but ¹⁸F-FDG PET may offer some improvement over a bone scan. There is, however, increasing evidence as to an important role for ¹⁸F-FDG PET in detecting or monitoring multiple myeloma, where ¹⁸F-FDG PET is clearly better than the bone scan, presumably because the ¹⁸F-FDG is identifying marrow-based disease at an early stage (Jadvar & Conti (2002) Skeletal Radiol. 31: 690-694).

The morphology of the metastasis itself appears to influence the ability of ¹⁸F-FDG PET scans to detect disease. At least in the case of breast cancer, different patterns of ¹⁸F-FDG uptake have been shown in sclerotic or lytic lesions, or in lesions with a mixed pattern. Furthermore, the precise localization of a metastasis in the skeleton may be important with regard to the extent of the metabolic response induced and detected by ¹⁸F-FDG uptake (Fogelman et al., (2005) Semin. Nucl. Med. 35: 135-142).

Functional imaging with PET and ¹⁸F-FDG may also have an important role in the imaging evaluation of patients with bone and soft tissue sarcoma, including guiding biopsy, detecting local recurrence in amputation stumps, detecting metastatic disease, predicting and monitoring response to therapy, and assessing for prognosis (Jadvar et al., (2004) Semin. Nucl. Med. 34: 254-261). Positron emission tomography has been shown to be superior to scintigraphy in the detection of metastases because it detects the tumor presence directly by relying on tumor metabolic activity, rather than indirectly by showing tumor involvement due to increased bone mineral turnover. This has allowed the detection of metastatic foci earlier with ¹⁸F-FDG PET than with bone scintigraphy (Jadvar et al., (2004) Semin. Nucl. Med. 34: 254-261; Peterson et al., (2003) 415: (Spec. No.), S120-S128).

Embodiments of the methods of the present disclosure allow interpretation of the ¹⁸F and ¹⁸F-FDG tissue distribution, even though the two radiopharmaceuticals are administered at the same time. This approach is based on the eventual localization of the ¹⁸F almost exclusively to the skeletal structures. The data indicated that blinded interpretation of the combined cocktail ¹⁸F/¹⁸F-FDG PET/CT results in a reliable diagnosis comparable to when ¹⁸F PET/CT and ¹⁸F-FDG PET/CT scans, obtained by administering the radiopharmaceuticals individually, are each interpreted separately, as shown in Table 1.

TABLE 1
Data from the seven subjects included in the pilot study and the results of the PET/CT
scans (LN's = lymph nodes; T/L = thoracic and lumbar spine; LUL = left upper lung; C/T/L =
cervical, thoracic and lumbar spine).

| | | | | | Cocktail | Cocktail |
|---|---|---|---|---|---|---|
| | | | | Cocktail | versus | versus |
| Age | Cancer | FDG findings | ¹⁸F findings | findings | ¹⁸F | ¹⁸F-FDG |
| 75 | Prostate | Ribs; pelvis; | Skull; ribs; | Skull; ribs; T/L; | equal | equal |
| | | femur; LN's | T/L; pelvis; | pelvis; femur; | | |
| | | | femur | LN's | | |
| 59 | Lung | LUL nodule, LN | Negative | LUL nodule; LN | equal | equal |
| 65 | Prostate | Pelvic LN's | Negative | Pelvic LN's | equal | equal |
| 68 | Colon | Liver; skeleton | Skull; | Liver; | equal | equal |
| | | | scapula; ribs; | skeleton | | |
| | | | C/T/L; pelvis; | | | |
| | | | femurs | | | |
| 31 | Sarcoma | Rt thigh | Negative | Rt thigh; | equal | equal |
| | | B/L lung nodules | | B/L lung nodules | | |
| 44 | Sarcoma | Soft tissue mass | Skull, T10, | Soft tissue mass, | Lesion | equal |
| | | (pubis) | pubis | T10, pubis | missed in | |
| | | | | | the skull | |
| | | | | | on | |
| | | | | | “cocktail” | |
| 41 | Sarcoma | Left iliac crest, | Right femur | Left iliac crest, | Lesion | equal |
| | | right femur | | right femur | missed in | |
| | | | | | the left | |
| | | | | | iliac crest | |
| | | | | | on ¹⁸F | |

In terms of radiation exposure for the patients, a ^{99m}Tc-MDP bone scan may result in a dose of 420 mRem. ¹⁸F-FDG PET/CT scans require radiation doses of approximately 2500 mRem (110 mRem/mCi from the ¹⁸F-FDG itself, and 1000 mRem from the low-dose CT scan), or a total of 2920 mRem. In contrast, by combining the ¹⁸F PET/CT and ¹⁸F-FDG PET/CT scans in a single scan can result in a total of 3150 mRem (110 mRem/mCi from ¹⁸F-FDG, 100 mRem/mCi from ¹⁸F and 1000 mRem from the low-dose CT). The newest PET/CT scanners have increased sensitivity and the dose of ¹⁸F-FDG may be decreased to 10 mCi, resulting in a total radiation exposure in the order of 2600 mRem from the combined ¹⁸F/¹⁸F-FDG PET/CT. The embodiments of the methods of the disclosure, therefore, may have the advantage that the patients, instead of receiving separate bone scans and PET/CT studies on different days, may receive one combined PET/CT study with potentially more utility, lower costs, lower radiation dose and much greater patient convenience.

### Image Analysis

Blinded interpretation of the ¹⁸F PET/CT scan, ¹⁸F-FDG PET/CT scan and the combined ¹⁸F/¹⁸F-FDG PET/CT scans was performed by two board certified Nuclear Medicine readers. A direct comparison for each detected lesion was performed among the 3 PET/CT scans.

In addition to the separate interpretation of the 3 scans from each subject, the CT data from the combined ¹⁸F/¹⁸F-FDG scan was used to create a bone mask that allows the display and/or overlay of ¹⁸F/¹⁸F-FDG in the osseous structures on the PET scan. In this way, various image processing steps can be performed on images produced from the 3 scans that can facilitate localization of legions within a subject's skeletal structure. A CT scan image can be matched, reformatted and/or resized to the dimensions of a PET scan image (i.e.: 128²×n from 512²×n). In addition, the resolution of the CT scan can be adjusted. As an alternative example, the CT and PET scans may be captured and imaged with similar or identical dimensions, which may obviate the need to reformat and/or resize either the CT or the PET scan image.

Accordingly, the CT scan image can be thresholded to eliminate substantially all soft tissue but keeping bone densities. It should be appreciated that one example of image thresholding can include a process whereby a color and/or grayscale image, such as a CT scan and/or PET scan image, can be converted into a binary image by determining whether one or more properties of substantially all image pixels are above or below a predefined threshold. Other image thresholding algorithms or techniques can be employed, including threshold inside or threshold outside methods. In this way, a binary or bitonal image of the subject's skeletal structure can be generated by determining properties of image pixels of the subject's soft tissue that can be differentiated from image pixels of the subject's osseous tissue. It should be appreciated that image thresholding can be performed interactively, with input from a user or operator. Alternatively, image thresholding can be performed by an automated image processing task configured to eliminate substantially all soft tissue to create an digital bone mask of the subject.

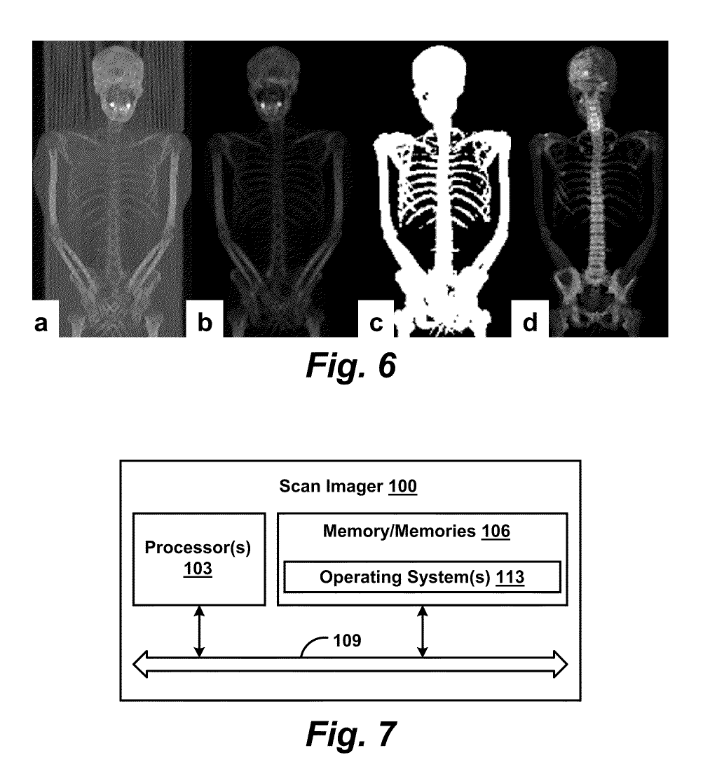

In one example, an automated image processing task or a user can identify osseous tissue and/or soft tissue in a scan image. Accordingly, image processing techniques can assign a predefined value (such as a zero in one non-limiting example) to substantially all soft tissue in the scan image. Image processing techniques can further assign (in one non-limiting example) non-zero values to osseous tissue in the scan image. Accordingly, image thresholding can employ the non-zero values in this particular example to generate a digital bone mask. Smoothing image processing techniques can also be employed on the generated digital bone mask to equalize the resolution of the bone mask to that of the PET image resolution. To facilitate localization of legions within a subject's skeletal structure, the PET image can be masked by the generated digital bone mask to form a bone image with a combined ¹⁸F/¹⁸F-FDG signal. These steps are illustrated by the scan images of FIG. 6.

Accordingly, a scan imager can perform the above noted image processing tasks in order to facilitate localization of lesions within a subject's skeletal structure. With reference to FIG. 7, shown is one additional example of the scan imager 100 that may include one or more embedded system, computer, and/or equivalent device equipped to perform the above image processing tasks according to an embodiment of the present disclosure. In implementing the above described embodiments, the scan imager 100 may include one or more processor circuits having a processor 103 and a memory 106 which are coupled to a local interface or bus 109. In this respect, the local interface or bus 109 may comprise, for example, a data bus with an accompanying control/address bus as can be appreciated. The scan imager 100 may also include or be coupled to a display device facilitating viewing of scan images as well as images processed and/or manipulated by the scan imager 100. Stored on the memory 106 and executable by the processor 103 are various components such as an operating system 113. In addition, it is understood that many other components may be stored in the memory 106 and executable by the processor(s) 103.

As set forth above, a number of components configured to perform the above noted image processing tasks are stored in the memory 106 and are executable by the processor 103. In this respect, the term “executable” refers to a program file that is in a form that can ultimately be run by the processor 103. Examples of executable programs may be, for example, a compiled program that can be translated into machine code in a format that can be loaded into a random access portion of the memory 106 and run by the processor 103, or source code that may be expressed in proper format such as object code that is capable of being loaded into a random access portion of the memory 106 and executed by the processor 103. An executable program may be stored in any portion or component of the memory 106 including, for example, random access memory, read-only memory, a hard drive, compact disk (CD), floppy disk, or other memory components.

The memory 106 is defined herein as volatile and/or nonvolatile memory and data storage components. Volatile components are those that do not retain data values upon loss of power. Nonvolatile components are those that retain data upon a loss of power. Thus, the memory 106 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 103 may represent multiple processors and the memory 106 may represent multiple memories that operate in parallel. In such a case, the local interface 109 may be an appropriate network that facilitates communication between any two of the multiple processors, between any processor and any one of the memories, or between any two of the memories, etc. The processor 103 may be of electrical, optical, or of some other construction as can be appreciated by those with ordinary skill in the art.

The operating system 113 is executed to control the allocation and usage of hardware resources such as the memory and processing time in the server 103. In this manner, the operating system 113 serves as the foundation on which applications depend as is generally known by those with ordinary skill in the art.

If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

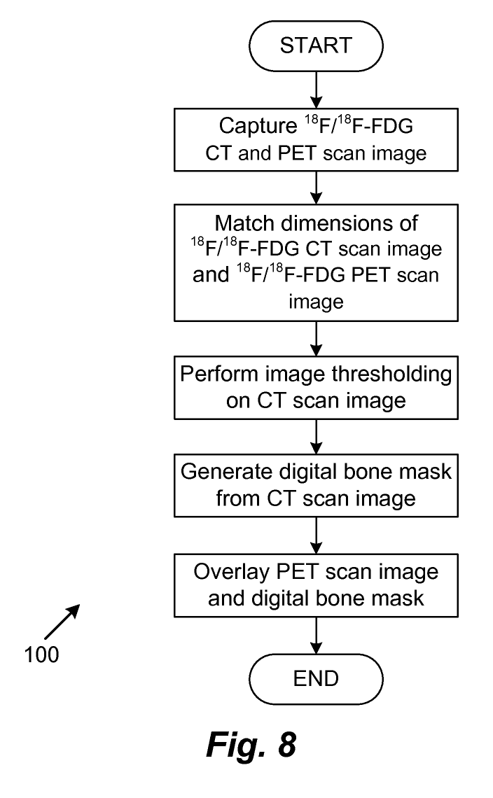

With reference to FIG. 8, shown is one example of the operation of the scan imager 100. The flow chart of FIG. 8 shows the functionality and operation of one non-limiting implementation of a scan imager 100. The flowchart may also be viewed as depicting a method in accordance with the disclosure. First, in box 200 an ¹⁸F/¹⁸F-FDG CT and PET scan image can be generated, transmitted and/or captured by scan imager 100. Next, in box 202 the dimensions of the CT scan image and PET scan image can be matched, reformatted, and/or resized to substantially the same dimensions to facilitate overlay of one image on another. Next, in box 204, image thresholding can be performed on the CT scan image to substantially remove soft tissue from the image, leaving osseous tissue in the image, which creates a digital bone mask in box 206. The image thresholding can be performed interactively, with input from a user, or by an automated process. Next, in box 208 the PET scan image can be overlaid on the generated digital bone mask. The image produced in box 208 can facilitate localization of legions within a subject's skeletal structure.

Although the flow chart of FIG. 8 shows a specific order of execution, it is understood that the order of execution may differ from that which is depicted. For example, the order of execution of two or more blocks may be scrambled relative to the order shown. Also, two or more blocks shown in succession in FIG. 8 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, where the functionality of the disclosed system is expressed in the form of software or code, it can be embodied in any computer-readable medium for use by or in connection with an instruction execution system such as, for example, a processor in a computer system or other system. In this sense, the functionality may comprise, for example, statements including instructions and declarations that can be fetched from the computer-readable medium and executed by the instruction execution system. In the context of the present disclosure, a “computer-readable medium” can be any medium that can contain, store, or maintain the executable software for use by or in connection with the instruction execution system.

The computer readable medium can comprise any one of many physical media such as, for example, electronic, magnetic, optical, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the functionality of various embodiments are described above with respect to the drawings as being embodied in software or code executed by general purpose hardware as discussed above, as an alternative the same may also be embodied in dedicated hardware or a combination of software/general purpose hardware and dedicated hardware. If embodied in dedicated hardware, the functionality of these components can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure.

One aspect of the present disclosure encompasses methods of determining the extent of cancer metastasis in a subject human or animal, comprising the steps of: (a) administering to a subject animal or human a first radiopharmaceutical and a second radiopharmaceutical; (b) capturing a positron emission tomography (PET) scan image of the subject administered a first radiopharmaceutical and a second radiopharmaceutical, where the PET scan image indicates the locations of the first radiopharmaceutical and the second radiopharmaceutical in the subject; and (c) identifying from the PET scan a site of co-localization of the first radiopharmaceutical and the second radiopharmaceutical in the subject, the co-localization indicating a metastatic cancer in the subject.

In embodiments of this aspect of the disclosure, the methods may further comprise: (i) capturing a computed tomography (CT) scan image of the subject animal or human, where the CT scan image can indicate the osseous material of the subject; (ii) adjusting the CT scan image to the size and resolution substantially similar to the PET image; (iii) adjusting the CT scan image data to retain only bone density data, thereby generating a digital bone mask image; (iv) overlaying the digital bone mask image with the PET scan image, thereby providing a PET scan image-digital bone mask image with the locations of the first radiopharmaceutical and the second radiopharmaceutical in the subject displayed thereon; and (v) identifying from the PET scan image-digital bone mask image overlay a site of co-localization of the first radiopharmaceutical and the second radiopharmaceutical in the subject.

In embodiments of the disclosure, the first radiopharmaceutical can be preferentially incorporated into bone, and the second radiopharmaceutical can be preferentially used by a cancer cell.

In embodiments of this aspect of the disclosure, the first radiopharmaceutical can be ¹⁸F⁻ and the second radiopharmaceutical can be ¹⁸F-2-deoxyglucose.

In the embodiments of the method of this aspect of the disclosure, the step of manipulating the CT scan image can further comprise performing image thresholding on the CT scan image.

Another aspect of the disclosure provides systems comprising: a processor; and a computer readable medium storing program code to be executed by the processor, where the program code comprises logic configured to: capture a positron emission tomography (PET) scan image of a subject administered a first radiopharmaceutical and a second radiopharmaceutical, the PET scan image indicating the locations of the first radiopharmaceutical and the second radiopharmaceutical in the subject; identify from the PET scan image the locations of the first radiopharmaceutical and the second radiopharmaceutical in the subject; capture a computed tomography (CT) scan image of the subject, the CT scan indicating osseous material in the subject; adjust the CT scan image to a size and a resolution substantially similar to the PET image; adjust the CT scan image to retain bone density data of the subject to form a digital bone mask image; overlay the PET scan image onto the digital bone mask, thereby forming a combined PET scan image-digital bone mask image overlay; and identify from the PET scan image-digital bone mask image overlay a site of co-localization of the first radiopharmaceutical and the second radiopharmaceutical in the subject.

In embodiments of this aspect of the disclosure, the first radiopharmaceutical can be absorbed by osseous material and the second radiopharmaceutical can be absorbed by cancer cells.

In the various embodiments of the disclosure, the first radiopharmaceutical can be ¹⁸F⁻ and the second radiopharmaceutical can be ¹⁸F-2-deoxyglucose.

In the various embodiments of this aspect of the disclosure, the logic configured to manipulate the CT scan image can further comprise logic configured to perform image thresholding on the CT scan image.

Yet another aspect of the disclosure provides systems, comprising: a processor; a means to capture a first scan image of a subject administered at least one tracer, the scan image indicating the at least one tracer in the subject; a means to capture a second scan image of the subject, the scan image indicating osseous material in the subject; and a means to adjust the second scan image to a size and a resolution substantially similar to the first image, whereby the second scan image forms a digital bone mask image overlay on the first scan image, thereby identifying from the first scan image a site of co-localization of the at least one tracer in the subject.

In embodiments of this aspect of the disclosure, the means to capture the first scan image of the subject can be a means to capture a positron emission tomography (PET) scan image of the subject, the PET scan image indicating the locations of the first radiopharmaceutical and the second radiopharmaceutical in the subject.

12. The system of claim 10, wherein:

In embodiments of this aspect of the disclosure, the means to capture a second scan image of the subject, the scan image indicating osseous material in the subject can be by computed tomography (CT).

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Now having described the embodiments of the disclosure, in general, the example describes some additional embodiments. While embodiments of present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Examples

### Example 1

### Evaluation of Combined ¹⁸F/¹⁸F-FDG PET Imaging of Mice

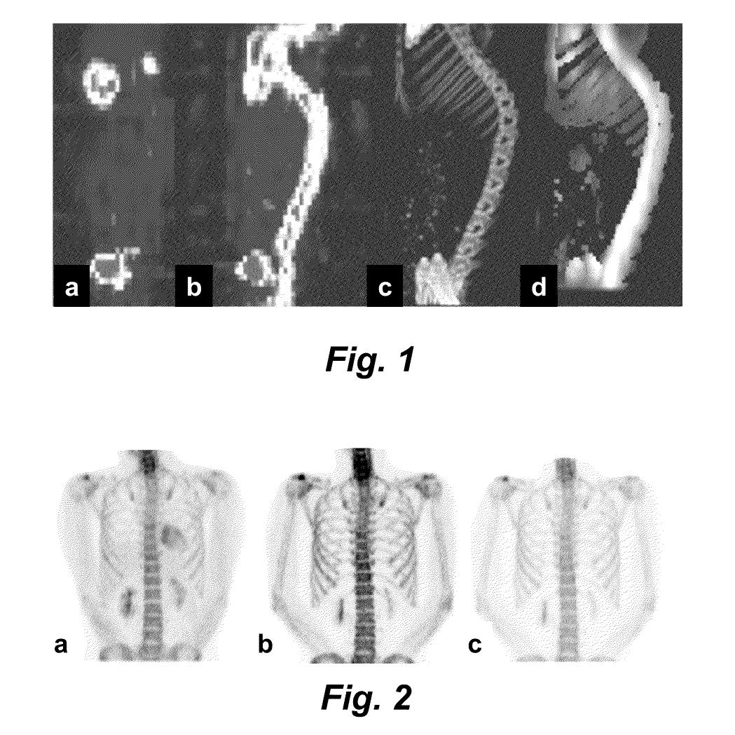

The feasibility of combined ¹⁸F/¹⁸F-FDG PET imaging was first tested in living mice. The animals were injected intravenously (i.v.) on separate days with ¹⁸F, ¹⁸F-FDG, and combined ¹⁸F/¹⁸F-FDG, and were then imaged by PET. Immediately after PET scanning, micro computed tomography (microCT) images were obtained. Through the aid of a bone mask from the microCT, and using the fiducial markers for co-registration of CT and PET images, the microPET images of mice obtained after administration of combined ¹⁸F/¹⁸F-FDG were processed to display the combined radiopharmaceuticals uptake in the skeleton only, as illustrated in FIG. 1.

### Example 2

### Evaluation of Combined ¹⁸F/¹⁸F-FDG PET/CT Versus ¹⁸F PET/CT in Humans

Interpretation of bone images acquired with combined ¹⁸F/¹⁸F-FDG PET/CT and ¹⁸F PET/CT were conducted separately. For this comparison, the image processing algorithm validated by the mice study, as well as blinded interpretation of the ¹⁸F/¹⁸F-FDG PET/CT scans, were used. Through image processing, the bone radiopharmaceutical uptake on the ¹⁸F/¹⁸F-FDG scan yielded comparable images to the ¹⁸F PET/CT done separately. Thus, combined ¹⁸F/¹⁸F-FDG cocktail radiopharmaceutical administration followed by a single PET/CT imaging appeared possible in this patient population, who had been referred for pre-therapy evaluation of the extent of a known malignancy.

In FIG. 2 are presented images obtained after combined ¹⁸F/¹⁸F-FDG, or ¹⁸F were administered, as well as the processed and combined ¹⁸F/¹⁸F-FDG images to display skeletal radiopharmaceutical uptake. The processed combined ¹⁸F/¹⁸F-FDG images are similar to the skeletal distribution of ¹⁸F alone.

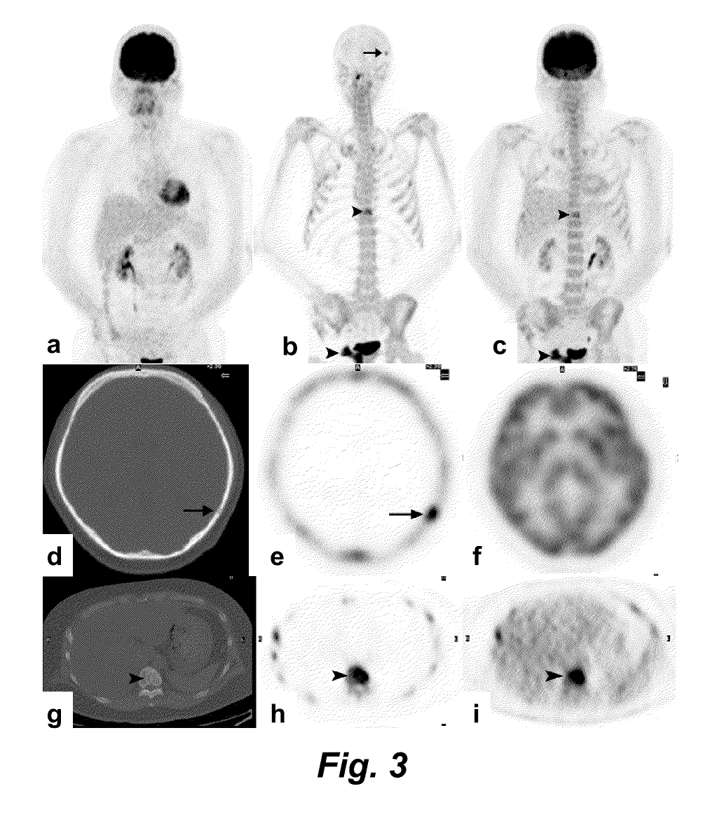

Blinded interpretation of the combined ¹⁸F/¹⁸F-FDG PET/CT scans without processing compared favorably with the ¹⁸F PET/CT scans. The results of this analysis are presented in Table 1. Only 1 skull lesion seen on an ¹⁸F scan was missed on the corresponding combined ¹⁸F/¹⁸F-FDG scan. However, this did not change the patient's treatment management since other skeletal lesions were identified. This case is presented in FIG. 3, which shows for a 44-year-old man with soft tissue sarcoma (subject No. 6): (a) MIP (maximum intensity projection) image of the ¹⁸F-FDG PET shows normal radiopharmaceutical uptake; (b) MIP image of the ¹⁸F PET shows intense radiopharmaceutical uptake in a skull lesion (arrow), as well as in the T10 vertebra and right pubis (arrowheads); (c) MIP of the combined ¹⁸F/¹⁸F-FDG PET scan that fails to show the skull lesion, but does show the skeletal lesions in the T10 vertebra and right pubis also noted on ¹⁸F PET (arrowheads). The skull lesion (arrow) was also seen on the transaxial CT (FIG. 3(d)) and the ¹⁸F PET scan (e), but not on the combined ¹⁸F/¹⁸F-FDG PET scan (f). The lesion in the T10 vertebra (arrowhead) was seen on transaxial CT (g), the ¹⁸F PET scan (h), and the combined ¹⁸F/¹⁸F-FDG PET scan (i).

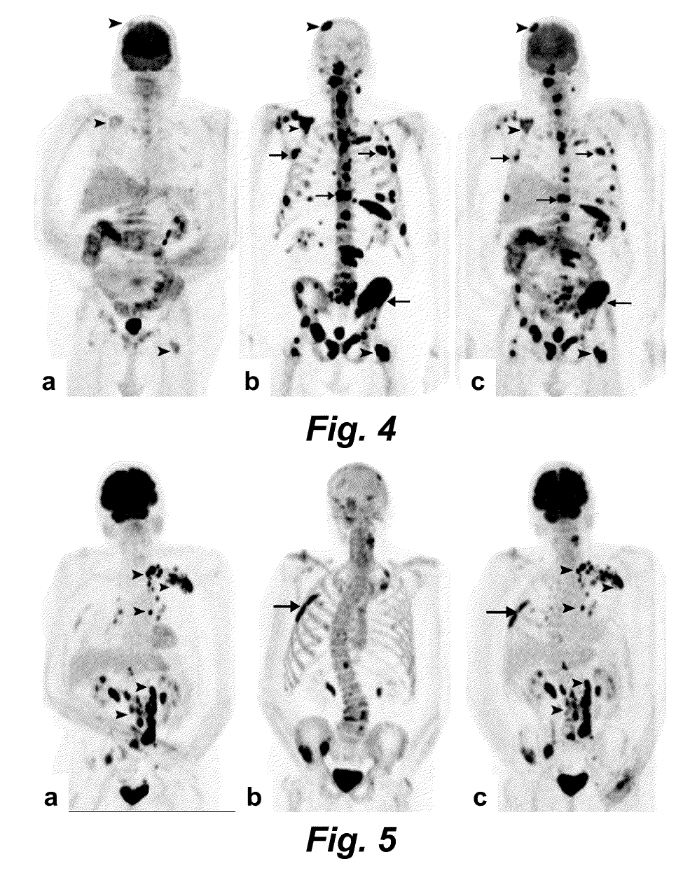

Both the ¹⁸F scan and the combined ¹⁸F/¹⁸F-FDG scan could show more extensive skeletal disease. This enhanced result was also seen in the example presented in FIG. 4 where: (a), the MIP image of the ¹⁸F-FDG PET shows faint radiopharmaceutical uptake in several skeletal lesions (arrowheads); (b) an MIP image of the ¹⁸F PET shows intense radiopharmaceutical uptake in multiple bone lesions, including improved visualization of those lesions also seen on ¹⁸F-FDG PET (of image (a)) (arrowheads), together with more extensive skeletal metastases (arrows); in (c) the MIP of the combined ¹⁸F/¹⁸F-FDG PET shows the skeletal lesions noted on ¹⁸F PET (arrowheads).

For all subjects examined, blinded interpretation of the combined ¹⁸F/¹⁸F-FDG PET/CT scans showed that ¹⁸F/¹⁸F-FDG images allow for accurate interpretation of the radiopharmaceutical uptake in the soft tissues, with similar findings as the ¹⁸F-FDG PET/CT imaging alone (no lesions missed). The results of this analysis are also detailed in Table 1.

In FIG. 5 are presented images of a 75-year-old man with prostate cancer, showing: (a) an MIP image of an ¹⁸F-FDG PET showing lymph nodes metastases (arrowheads), as well as faint uptake in osseous lesions, such as a right rib lesion (arrow); (b) an MIP image of an ¹⁸F PET shows intense radiopharmaceutical uptake in multiple bone lesions, including the right rib lesion (arrow) that was seen on ¹⁸F-FDG PET; (c) an MIP of the combined ¹⁸F/¹⁸F-FDG PET shows both the lesions noted on ¹⁸F-FDG PET (arrowheads), and the skeletal lesions noted on ¹⁸F PET (reference right rib lesion marked with arrow).

### Example 3

### Pre-Clinical Study

A total of 4 mice were imaged with microPET approximately 1 hour after tail vein administration of ¹⁸F, ¹⁸F-FDG, or combined ¹⁸F/¹⁸F-FDG, each on a separate day. Immediately after the combined ¹⁸F/¹⁸F-FDG PET, a microCT scan was also obtained. Fiducial markers were placed for co-registration of the microPET and microCT images. PET images were acquired using a MicroPET rodent R4 scanner (Concorde Microsystems). CT images were obtained using an eXplore RS MicroCT system (GE Medical Systems).

The CT scan data was used to create a bone mask that allowed the display of ¹⁸F/¹⁸F-FDG in the osseous structures of the PET scan. The image processing involved in this pre-clinical study required: (a) obtaining a bone mask from CT scan data; (b) combining the ¹⁸F/¹⁸F-FDG PET data with the microCT with co-registration of the two images (using fiducial markers); and (c) displaying the ¹⁸F/¹⁸F-FDG uptake into the osseous structures on the PET scan. The processed images of the combination ¹⁸F/¹⁸F-FDG PET scan were compared with the images obtained from separate ¹⁸F PET and ¹⁸F-FDG PET scans.

### Example 4

### Exclinical Study

A total of 7 subjects were recruited for this pilot phase study. All were men, 31-75 years-old (average: 54.7±16.2). Their underlying malignancies were prostate cancer (2 subjects), soft tissue sarcoma (2 subjects), osteosarcoma (1 subject), colon cancer (1 subject) and lung cancer (1 subject). Each patient had separate ¹⁸F PET/CT and ¹⁸F-FDG PET/CT scans, and then returned for a combined administration of ¹⁸F/¹⁸F-FDG for the third PET/CT scan. All three scans for a patient were obtained within a two week interval.

### Example 5

### PET/CT Protocols and Image Reconstruction

While it is contemplated that any suitable PET/CT scanner may be used in the methods and systems of the present disclosure, the PET/CT images as shown in FIGS. 1-6, for example, were obtained in 2D mode using a GE Discovery LT scanner (GE Healthcare). The PET emission scans were corrected using segmented attenuation data of the conventional transmission scan. The PET images were reconstructed with a standard iterative algorithm (OSEM, two iterative steps, 28 subsets) using GE software release 5.0. All images were reformatted into axial, coronal, and sagital views and viewed with the software provided by the manufacturer (eNtegra, GE Medical Systems, Haifa, Israel).

The prescribed radiopharmaceutical doses were 15 mCi for ¹⁸F-FDG administered alone, 10 mCi for the ¹⁸F (NaF) administered alone, and 15 mCi ¹⁸F-FDG+5 mCi ¹⁸F administered as the combined (cocktail). For the combined ¹⁸F/¹⁸F-FDG scans, the 2 radiopharmaceuticals were delivered from the local cyclotron facility in separate syringes, and administered sequentially and without delay between the two doses. PET and CT images were obtained starting at 60 minutes after intravenous administration of each of the radiopharmaceuticals.

We claim:

1. A method of determining the extent of cancer metastasis in a subject human or animal, comprising the steps of:
(a) administering to a subject animal or human a first radiopharmaceutical and a second radiopharmaceutical;
(b) capturing a positron emission tomography (PET) scan image of the subject administered a first radiopharmaceutical and a second radiopharmaceutical, wherein the PET scan image indicates the locations of the first radiopharmaceutical and the second radiopharmaceutical in the subject; and
(c) identifying from the PET scan a site of co-localization of the first radiopharmaceutical and the second radiopharmaceutical in the subject, whereby the co-localization indicates a metastatic cancer in the subject.

2. The method of claim 1, further comprising:
(i) capturing a computed tomography (CT) scan image of the subject animal or human, wherein the CT scan image indicates the osseous material of the subject;
(ii) adjusting the CT scan image to the size and resolution substantially similar to the PET image;
(iii) adjusting the CT scan image data to retain only bone density data, thereby generating a digital bone mask image;
(iv) overlaying the digital bone mask image with the PET scan image, thereby providing a PET scan image-digital bone mask image with the locations of the first radiopharmaceutical and the second radiopharmaceutical in the subject displayed thereon; and
(v) identifying from the PET scan image-digital bone mask image overlay a site of co-localization of the first radiopharmaceutical and the second radiopharmaceutical in the subject.

3. The method of claim 1, wherein the first radiopharmaceutical is preferentially incorporated into bone, and the second radiopharmaceutical is preferentially used by a cancer cell.

4. The method of claim 1, wherein the first radiopharmaceutical is ¹⁸F⁻ and the second radiopharmaceutical is ¹⁸F-2-deoxyglucose.

5. The system of claim 2, wherein the step of manipulating the CT scan image further comprises performing image thresholding on the CT scan image.

6. A system, comprising:
a processor; and
a computer readable medium storing program code to be executed by the processor, the program code comprising logic configured to:
capture a positron emission tomography (PET) scan image of a subject administered a first radiopharmaceutical and a second radiopharmaceutical, the PET scan image indicating the locations of the first radiopharmaceutical and the second radiopharmaceutical in the subject;
identify from the PET scan image the locations of the first radiopharmaceutical and the second radiopharmaceutical in the subject;
capture a computed tomography (CT) scan image of the subject, the CT scan indicating osseous material in the subject;
adjust the CT scan image to a size and a resolution substantially similar to the PET image;
adjust the CT scan image to retain bone density data of the subject to form a digital bone mask image;
overlay the PET scan image onto the digital bone mask, thereby forming a combined PET scan image-digital bone mask image overlay; and
identify from the PET scan image-digital bone mask image overlay a site of co-localization of the first radiopharmaceutical and the second radiopharmaceutical in the subject.

7. The system of claim 6, wherein the first radiopharmaceutical is absorbed by osseous material and the second radiopharmaceutical is absorbed by cancer cells.

8. The system of claim 6, wherein the first radiopharmaceutical is ¹⁸F⁻ and the second radiopharmaceutical is ¹⁸F-2-deoxyglucose.

9. The system of claim 6, wherein the logic configured to manipulate the CT scan image further comprises logic configured to perform image thresholding on the CT scan image.

10. A system, comprising:
a processor; and
a means to capture a first scan image of a subject administered at least one tracer, the scan image indicating the at least one tracer in the subject;
a means to capture a second scan image of the subject, the scan image indicating osseous material in the subject;
a means to adjust the second scan image to a size and a resolution substantially similar to the first image, whereby the second scan image forms a digital bone mask image overlay on the first scan image, thereby identifying from the first scan image a site of co-localization of the at least one tracer in the subject.

11. The system of claim 10, wherein:
the means to capture the first scan image of the subject is a means to capture a positron emission tomography (PET) scan image of the subject, the PET scan image indicating the locations of the first radiopharmaceutical and the second radiopharmaceutical in the subject.

12. The system of claim 10, wherein:
the means to capture a second scan image of the subject, the scan image indicating osseous material in the subject is by computed tomography (CT).
